(19) United States
(12) Patent Application Publication
(10) Pub. No.: US 2026/0050161 A1
(43) Pub. Date: Feb. 19, 2026

(54) HEADS-UP DISPLAY INFRARED IMAGE REFLECTION ENHANCEMENT

(71) Applicant: VISTEON GLOBAL TECHNOLOGIES, INC., Van Buren Township, MI (US)

(72) Inventors: Pawel Murzyn, Chelmsford (GB); Jan Kisak Rasmussen, Aalborg (DK); Mandar Joshi, Pune (IN)

(73) Assignee: VISTEON GLOBAL TECHNOLOGIES, INC., Van Buren Township, MI (US)

(21) Appl. No.: 19/296,422

(22) Filed: Aug. 11, 2025

Related U.S. Application Data
(60) Provisional application No. 63/682,782, filed on Aug. 13, 2024.

(51) Int. Cl. G02B 27/01; B60K 35/23

(52) U.S. Cl. CPC G02B 27/0101; B60K 35/23; B60K 2360/23

(57) ABSTRACT

A heads-up display includes an image display and a reflector. The image display has an active area and a periphery around the active area. The image display is operational to project a visible image from the active area. The reflector is optically aligned with the image display, oriented to reflect the visible image received from the image display toward an eye box, and reflect an infrared image received from the eye box toward the image display. The reflector includes a visible reflective layer that reflects the visible image, an intermediate layer adjacent to the visible reflective layer and operational to block the visible image and transmit the infrared image, and an infrared reflective layer adjacent to the intermediate layer, on an opposite side of the intermediate layer as the visible reflective layer, and operational to reflect the infrared image.

### CROSS-REFERENCE TO RELATED APPLICATIONS

This application claims the benefit of U.S. Provisional Application Number 63/682,782, filed Aug. 13, 2024, which is hereby incorporated by reference in its entirety.

### TECHNICAL FIELD

The present disclosure generally relates to systems and methods for heads-up display infrared image reflection enhancement.

### BACKGROUND

Standard reflective coatings used in automotive heads-up displays provide a high reflectivity of visible images. However, such reflective coatings are not as efficient for non-visible images. As such, a performance of driver monitoring systems that depend on the non-visible images are impeded.

Accordingly, those skilled in the art continue with research and development efforts in the field of heads-up displays suitable for use with driver monitoring systems.

### SUMMARY

A heads-up display is provided herein. The heads-up display includes an image display and a reflector. The image display has an active area and a periphery around the active area. The image display is operational to project a visible image from the active area. The reflector is optically aligned with the image display. The reflector is oriented to reflect the visible image received from the image display toward an eye box and reflect an infrared image received from the eye box toward the image display. The eye box is a three-dimensional region in which a user of the heads-up display sees the visible image. The reflector includes a visible reflective layer that reflects the visible image, an intermediate layer adjacent to the visible reflective layer and operational to block the visible image and transmit the infrared image, and an infrared reflective layer adjacent to the intermediate layer, on an opposite side of the intermediate layer as the visible reflective layer, and operational to reflect the infrared image.

A method for enhanced infrared image reflection in a heads-up display is provided herein. The method includes projecting a visible image from an active area of an image display. The image display has a periphery around the active area. The method further includes reflecting the visible image received at a reflector from the image display toward an eye box. The reflector is optically aligned with the image display. The eye box is a three-dimensional region in which a user of the heads-up display sees the visible image. The method includes reflecting an infrared image received at the reflector from the eye box toward the image display. The reflector includes a visible reflective layer that reflects the visible image, an intermediate layer adjacent to the visible reflective layer and operational to block the visible image and transmit the infrared image, and an infrared reflective layer adjacent to the intermediate layer, on an opposite side of the intermediate layer as the visible reflective layer, and operational to reflect the infrared image.

A vehicle is provided herein. The vehicle includes a heads-up display operational to project a visible image into an eye box. The heads-up display includes an image display and a reflector. The image display has an active area and a periphery around the active area. The image display is operational to project a visible image from the active area. The reflector is optically aligned with the image display. The reflector is oriented to reflect the visible image received from the image display toward the eye box, and reflect an infrared image received from the eye box toward the image display. The eye box is a three-dimensional region in which a user of the heads-up display sees the visible image. The reflector includes a visible reflective layer that reflects the visible image, an intermediate layer adjacent to the visible reflective layer and operational to block the visible image and transmit the infrared image, and an infrared reflective layer adjacent to the intermediate layer, on an opposite side of the intermediate layer as the visible reflective layer, and operational to reflect the infrared image.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 illustrates a context of a vehicle.

FIG. 2 illustrates a cross-section diagram of a heads-up display in accordance with one or more exemplary embodiments.

FIG. 3 illustrates a cross-sectional diagram of a reflector in accordance with one or more exemplary embodiments.

FIG. 4 illustrates a cross-sectional diagram of another reflector in accordance with one or more exemplary embodiments.

FIG. 5 illustrates a cross-sectional diagram of still another reflector in accordance with one or more exemplary embodiments.

FIG. 6 illustrates a graph of a transmittance spectrum of IR transmitting acrylic layer.

FIG. 7 illustrates a graph of a transmittance spectrum of Visualplus IR films.

FIG. 8 illustrates a graph of coverage in an eye box with the modified infrared reflective layer surface in accordance with one or more exemplary embodiments.

FIG. 9 illustrates a cross-section diagram of another heads-up display in accordance with one or more exemplary embodiments.

The present disclosure may have various modifications and alternative forms, and some representative embodiments are shown by way of example in the drawings and will be described in detail herein. Novel aspects of this disclosure are not limited to the particular forms illustrated in the above-enumerated drawings. Rather, the disclosure is to cover modifications, equivalents, and combinations falling within the scope of the disclosure as encompassed by the appended claims.

### DETAILED DESCRIPTION

Embodiments of the disclosure generally provide for a heads-up display (HUD) suitable for use with an infrared (IR) driver monitoring system (DMS). The heads-up display may be implemented as a panoramic display or a floating heads-up display. A reflector in the heads-up display generally includes an optical stack with multiple layers. A front layer is a visible reflective layer that reflects visible light received from an image display in the heads-up display toward an eye box for a user (e.g., a driver) of the heads-up display. A back layer is an infrared reflective layer that reflects infrared light received from the eye box toward the image display. An intermediate layer allows passage of the infrared light while blocking the visible light.

An infrared camera may be positioned along a periphery of the image display or near the image display to sense the infrared light. The sensed infrared light creates an infrared image used by the driver monitoring system. Existing visible light spectrum coatings optimized for p-polarization reflectance have reduced infrared reflectance between 850-950 nanometers (nm). Typical reflectance ranges 15-20%, that limits driver monitoring system fidelity and puts increase demand on infrared illuminators. The optical stack that may bring the infrared reflectance to above 70% without impacting visible light performance.

Separation of infrared reflective layer from the visible reflective layer offers a benefit of improving coverage of the eye box with infrared camera field of view without impacting the visible reflective layer. The infrared reflective layer may also be shaped or modified to adjust the infrared camera viewing path.

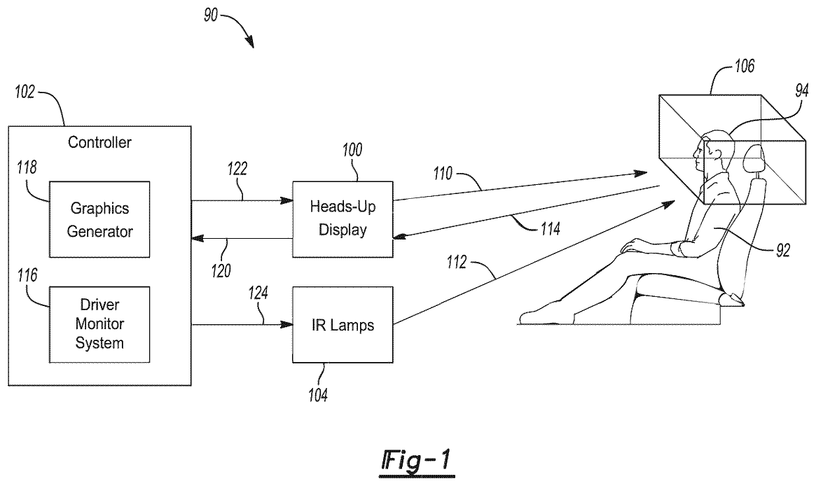

FIG. 1 illustrates a context of a vehicle 90. The vehicle 90 may house a user 92 (or person or drier). The vehicle 90 may include a heads-up display 100, a controller 102 and one or more (one illustrated) infrared lamps 104. An eye box 106 may be defined as a space around a head 94 of the user 92 in which the user 92 may view a visible image 110 generated and present by the heads-up display 100. An illumination light 112 generated by the infrared lamp 104 may illuminate at least the head 94 of the user 92. The illumination light 112 reflected from the user 92 may be returned to the heads-up display 100 as an infrared image 114. The controller 102 may include a driver monitoring system 116 and a graphics generator 118. The driver monitoring system 116 may receive an IR signal 120 from the heads-up display 100. The IR signal 120 may be representative of the infrared image 114 detected by the heads-up display 100. The graphics generator 118 generally presents a visible (VIS) signal 122 to the heads-up display 100. The VIS signal 122 provides data used by the heads-up display 100 to generate the visible images 110. An IR signal 124 is generated by the controller 102 and received by the IR lamps 104. The IR signal 124 controls a brightness of the illumination light 112.

The vehicle 90 may include mobile vehicles such as automobiles, trucks, motorcycles, boats, trains and/or aircraft. Other types of vehicles 90 may be implemented to meet the design criteria of a particular application.

The user 92 may be a driver or other occupant of the vehicle 90. The user 92 may be monitored by the driver monitoring system 116 through the infrared image 114 received by the heads-up display 100 through the eye box 106.

The heads-up display 100 may implement a projector that generates useful information for the user 92 in the visible images 110 about the operating conditions of the vehicle 90. For example, the heads-up display 100 may present instrumentation data (e.g., speed, tachometer, fuel, temperature, etc.) to the user 92. In some embodiments, the heads-up display 100 may also provide video images (e.g., a rear-view camera video, a forward-view camera video, etc.) to the user 92. In other embodiments, the heads-up display 100 may further provide alphanumeric information to the user 92.

The heads-up display 100 is also operational to detect the infrared images 114 of the user 92 as received from the eye box 106. The IR signal 120 generated by the heads-up display 100 is representative of the infrared images 114.

The controller 102 may implement one or more electronic control units. The controller 102. The controller 102 is operational to generate the VIS signal 122 to determine the visible images 110 that the heads-up display 100 provides to the user 92.

The controller 102 is also operational to receive the IR signal 120 as input to the driver monitoring system 116.

The infrared lamp 104 implements a source of infrared light. The infrared lamp 104 is operational to generate the illumination light 112 in response to the IR signal 124. The illumination light 112 illuminates the user 92 in the infrared wavelengths.

The eye box 106 is a three-dimensional region in which the user 92 of the heads-up display 100 may see the visible images 110 regardless of a current location and/or orientation of the head 94 of the user 92. In various embodiments, the eye box 106 may define a position of the driver's eyes is within a box of ±90 millimeters (mm) in width and ±50 mm in height. Other sizes of eye boxes 106 may be implemented to meet the design criteria of a particular application.

The driver monitoring system 116 is operational to monitor one or more conditions (e.g., alertness, eye direction, eyes open/closed, head orientation, etc.) of the user 92. The driver monitoring system 116 may generate a caution signal (e.g., physical, optical, acoustic and/or hepatic) upon determining that the user 92 is not alert and driving carefully.

The graphics generator 118 (or picture generation unit) is operational to generate the VIS signal 122. The graphics generator 118 may receive data signals from a variety of sensors (not shown) in the vehicle 90. The sensor data is used to generate the graphics, numbers, symbols, etc. in the visible image 110 produced by the heads-up display 100.

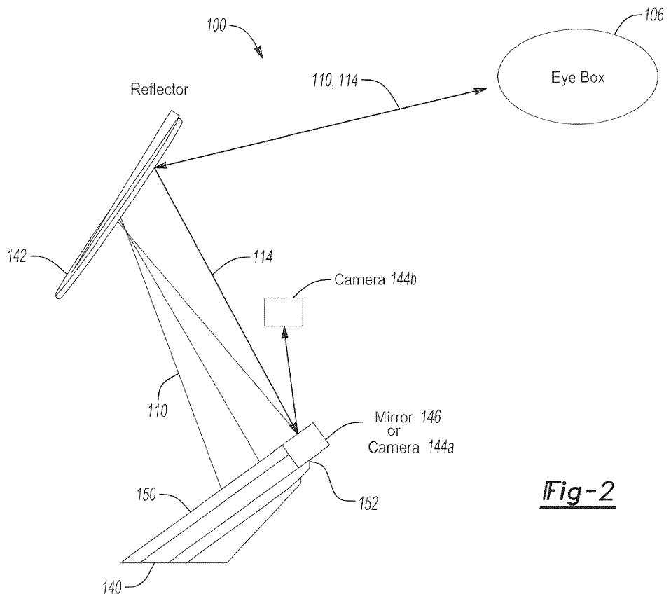

FIG. 2 illustrates a cross-section diagram of an example implementation of the heads-up display 100 in accordance with one or more exemplary embodiments. The heads-up display 100 generally includes an image display 140, a reflector 142 a camera 144a or 144b, and an optional mirror 146. The image display 140 may generate and present the visible image 110 to the reflector 142. The reflector 142 may redirect the visible image 110 to the eye box 106. The infrared image 114 may be received through the eye box 106 at the reflector 142. The reflector 142 may redirect the infrared image 114 to either the camera 144a or the optional mirror 146. Where the mirror 146 is implemented, the mirror 146 may reflect the infrared image 114 to the camera 144b.

The image display 140 generally implements a visible display. The image display 140 may generate the visible image 110 as a color image or a black-and-white image. The image display 140 has an active area 150 that presents the visible image 110. A periphery 152 of the image display 140 may surround the active area 150. In various embodiments, the image display 140 may include a thin-film transistor (TFT) display.

The reflector 142 implements a multi-spectral reflector. The reflector 142 is operational to reflect the visible images 110 received from the image display 140 with a high efficiency (e.g., >90%) and reflect the infrared images 114 with another high efficiency (e.g., >70%).

The cameras 144a and 144b implement infrared DMS cameras. The cameras 144a and 144b are operational to detect the infrared images 114 and convert the images into the IR signal 120 used by the driver monitoring system 116. Where implemented, the camera 144a may be mounted on or proximate the periphery 152 of the image display 140 and oriented to receive the infrared images 114 directly from the reflector 142.

Where implemented, the camera 144b may be mounted away from the image display 140 and is oriented to receive the infrared images 114 as reflected from the mirror 146. The mirror 146 may be disposed on the periphery 152 of the image display 140 and oriented to redirect the infrared images 114 from the reflector 142 to the camera 144b.

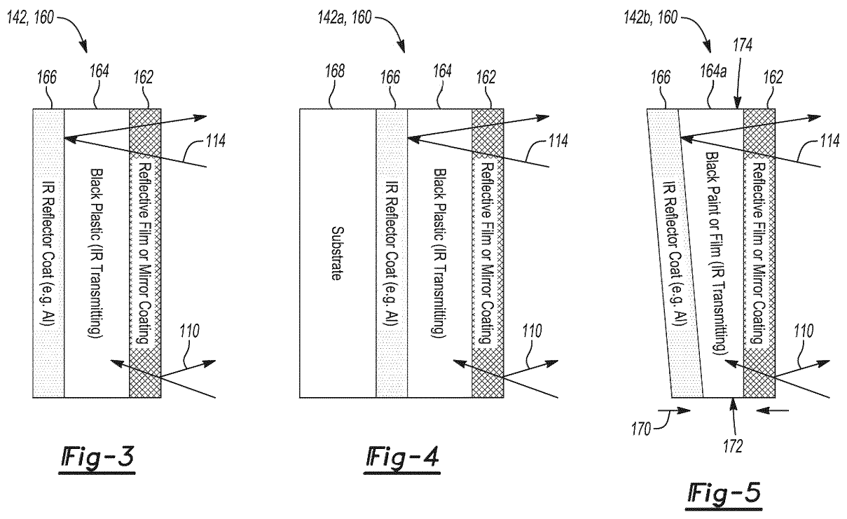

FIG. 3 illustrates a cross-sectional diagram of an example embodiment of the reflector 142 in accordance with one or more exemplary embodiments. The reflector 142 generally includes an optical stack 160 with several layers 162, 164 and 166. A first visible reflective layer 162 (or film or coating), that reflects visible light and transmits infrared light, is followed by a second intermediate layer 164 (or film) that transmits the infrared light and blocks the visible light. The two layers 162 and 164 are followed by the highly-reflective third infrared reflective layer (or mirror or surface) (e.g., a reflective metal such as aluminum). The visible reflective layer 162 may be deposited on or laminated to the intermediate layer 164. The intermediate layer 164 may be deposited on or laminated to the infrared reflective layer 166. In various embodiments, the layers 162, 164 and 166 may be combined or there may be airgaps between them. In various embodiments, the visible reflective layer 162 may be a holographic (HOE) layer or a diffractive (DOE) layer. Other types of reflectors may be implemented to meet the criteria of a particular design application.

The visible images 110 are substantially reflected by the first visible reflective layer 162 toward the eye box 106. Any visible images 110 and other ambient visible light that passes through the first visible reflective layer 162 are absorbed by the second intermediate layer 164 to avoid double reflections (e.g., ghost images). The infrared images 114 are substantially transmitted by first visible reflective layer 162 and the second intermediate layer 164, reflected by the third infrared reflective layer 166, and subsequently transmitted back by through the second intermediate layer 164 and the first visible reflective layer 162 in the direction of camera 144a or the mirror 146.

FIG. 4 illustrates a cross-sectional diagram of another example embodiment of a reflector 142a in accordance with one or more exemplary embodiments. The reflector 142a may be a variation of the reflector 142. The reflector 142a includes the first visible reflective layer 162, the second intermediate layer 164, the third infrared reflective layer 166, and a substrate 168. The substrate 168 is attached to the third infrared reflective layer 166 to provide mechanical support for the optical stack 160.

FIG. 5 illustrates a cross-sectional diagram of still another example embodiment of a reflector 142b in accordance with one or more exemplary embodiments. The reflector 142b may be a variation of the reflector 142a and/or the reflector 142. The reflector 142b includes the first visible reflective layer 162, a second intermediate layer 164a, and the third infrared reflective layer 166. The second intermediate layer 164a generally has a thickness 170 that varies from one side 172 of the optical stack 160 to an opposite side 174 of the optical stack 160. The varying thickness 170 of the second intermediate layer 164a generally results in the third infrared reflective layer 166 being tilted relative to the first visible reflective layer 162. The tilt may establish a direction the infrared images 114 toward the camera 144a or the mirror 146 in the periphery 152 of the image display 140. To improve the field of view for the DMS camera 144a or 144b, the third infrared reflecting layer 166 may be modified to have different angle and/or shape (e.g., nonplanar shape) relative to a reflective surface to control a direction of the reflected infrared images 114.

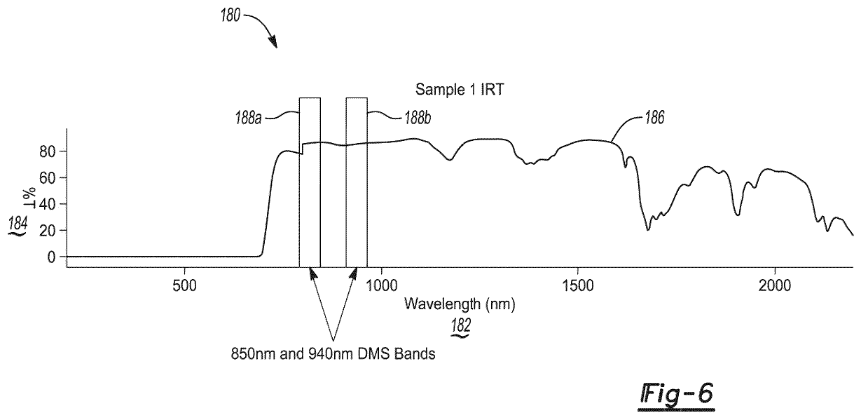

FIG. 6 illustrates a graph 180 of a transmittance spectrum of IR transmitting acrylic layer. The graph 180 includes an X-axis 182 in units of wavelength, and a Y-axis 184 in units of percent transmittance. A curve 186 illustrates the transmittance of an example IR transmitting acrylic layer. Bands 188a-188b are the 850 nm and 940 nm infrared bands used by the DMS infrared cameras 144a-144b for the driver monitoring system 116.

In various embodiments, the infrared-transmitting intermediate layer 164,164a may include, but is not limited to, visible blocking films such as Acrylite® IR acrylic 1146, Visualplus IR film, and Plexiglas® IR acrylic 3143 or thicker, and a visible light blocking plastic substrate. The layers 162, 164 and 166 may be combined into a single component or may be separated (physically and or by an airgap). Other physical implementations may be implemented to meet the design criteria of a particular application.

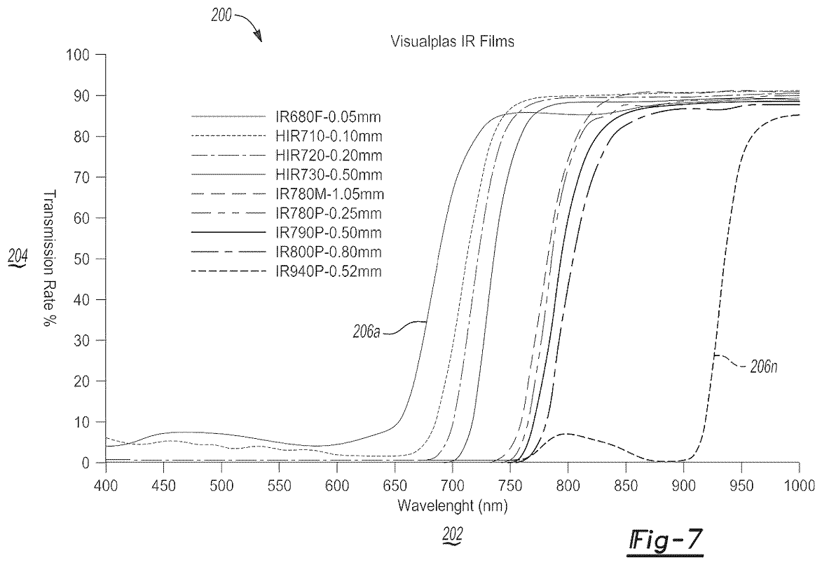

FIG. 7 illustrates a graph 200 of a transmittance spectrum of the Visualplus IR films. The graph 200 includes an X-axis 202 in units of wavelength, and a Y-axis 204 in units of percent transmittance. Curves 206a-206n illustrate the transmittances of the Visualplus IR films at different thicknesses.

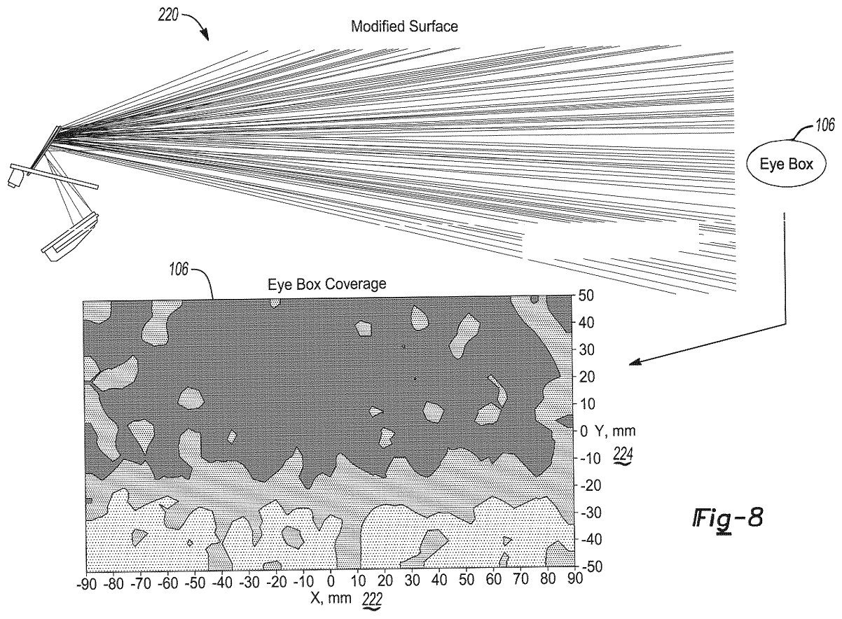

FIG. 8 illustrates a graph 220 of coverage in the eye box 106 with the modified infrared reflective layer surface in accordance with one or more exemplary embodiments. The eye box coverage includes an x-axis in units of millimeters and a Y-axis in units of millimeters. A shading of the in the eye box 106 indicates how well the DMS infrared cameras 144a-144b capture the infrared images 114.

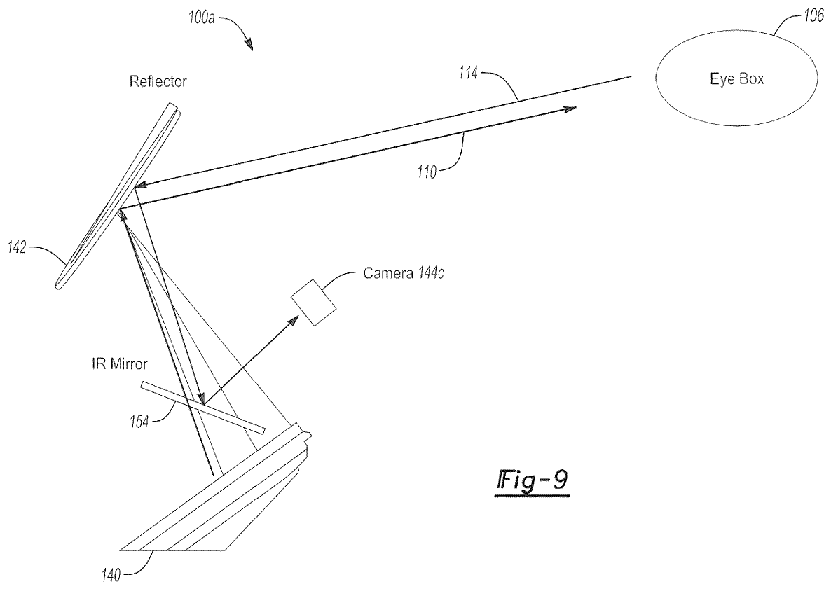

FIG. 9 illustrates a cross-section diagram of an example implementation of another heads-up display 100a in accordance with one or more exemplary embodiments. The heads-up display 100a may be a variation of the heads-up display 100. The heads-up display 100a generally includes the image display 140, the reflector 142 an infrared camera 144c, and an infrared mirror 154. The image display 140 may generate and present the visible image 110 through the infrared mirror 154 to the reflector 142. The reflector 142 may redirect the visible image 110 to the eye box 106. The infrared image 114 may be received through the eye box 106 at the reflector 142. The reflector 142 may redirect the infrared image 114 to the infrared mirror 154. The infrared mirror 154 may direct the infrared images 114 to the camera 144c.

The camera 144c implements an infrared camera of the driver monitoring system 116, similar to the camera 144a and/or the camera 144a. The camera 144c is mounted apart from the image display 140 and the reflector 142. The camera 144c is mounted outside the optical path used by the visible images 110.

The infrared reflective layer 166 and the infrared mirror 154 may be used to couple an infrared DMS field-of-view with heads-up display imaging path to further improve eye box coverage.

Embodiments of the system and/or method generally provides a multilayer structure visible reflective layer on top of an infrared transmitting/visible blocking layer followed by a high infrared reflective layer. The visible blocking layer may be a plastic layer, a film layer, or a paint layer. A surface of the infrared reflective layer may have a different angle and/or shape than the front surface to improve camera eye box coverage. The infrared mirror (e.g., a hot mirror) with high visible light transmission may be used to couple the camera and picture generation unit (PGU) optical paths.

Those having ordinary skill in the art will recognize that terms such as “above,” “below,” “front,” “back,” “upward,” “downward,” “top,” “bottom,” etc., may be used descriptively herein without representing limitations on the scope of the disclosure. Furthermore, the present teachings may be described in terms of functional and/or logical block components and/or various processing steps. Such block components may be comprised of various hardware components, software components executing on hardware, and/or firmware components executing on hardware.

The foregoing detailed description and the drawings are supportive and descriptive of the disclosure, but the scope of the disclosure is defined solely by the claims. As will be appreciated by those of ordinary skill in the art, various alternative designs and embodiments may exist for practicing the disclosure defined in the appended claims.

1. A heads-up display comprising:
an image display that has an active area and a periphery around the active area, wherein the image display is operational to project a visible image from the active area; and
a reflector optically aligned with the image display, wherein:
the reflector is oriented to reflect the visible image received from the image display toward an eye box and reflect an infrared image received from the eye box toward the image display, wherein the eye box is a three-dimensional region in which a user of the heads-up display sees the visible image; and
the reflector includes:
a visible reflective layer that reflects the visible image;
an intermediate layer adjacent to the visible reflective layer and operational to block the visible image and transmit the infrared image; and
an infrared reflective layer adjacent to the intermediate layer, on an opposite side of the intermediate layer as the visible reflective layer, and operational to reflect the infrared image.

2. The heads-up display according to claim 1, wherein the infrared reflective layer is tilted relative to the visible reflective layer to direct the infrared image received from the eye box toward the periphery of the image display.

3. The heads-up display according to claim 2, wherein a thickness of the intermediate layer varies from one side of the reflector to an opposite side to establish the tilt of the infrared reflective layer relative to the visible reflective layer.

4. The heads-up display according to claim 1, further comprising:
an infrared camera operational to sense the infrared image reflected by the reflector.

5. The heads-up display according to claim 4, further comprising:
a mirror disposed on the periphery of the image display and aligned to reflect the infrared image toward the infrared camera.

6. The heads-up display according to claim 4, further comprising:
an infrared mirror disposed between the image display and the reflector and operational to:
transmit the visible image from the active area of the image display to the visible reflective layer; and
reflect the infrared image from the infrared reflective layer to the infrared camera.

7. The heads-up display according to claim 4, wherein the infrared reflective layer has a nonplanar shape that directs the infrared image toward the infrared camera.

8. The heads-up display according to claim 1, wherein the reflector further comprises:
a substrate operational to mechanically support the infrared reflective layer.

9. The heads-up display according to claim 1, wherein the visible reflective layer is metal coating.

10. The heads-up display according to claim 1, wherein the intermediate layer is one or more of an acrylic layer, a plastic layer, and a paint layer.

11. The heads-up display according to claim 1, wherein the infrared reflective layer is metal coating.

12. A method for enhanced infrared image reflection in a heads-up display, the method comprising:
projecting a visible image from an active area of an image display, wherein the image display has a periphery around the active area;
reflecting the visible image received at a reflector from the image display toward an eye box, wherein the reflector is optically aligned with the image display, and the eye box is a three-dimensional region in which a user of the heads-up display sees the visible image; and
reflecting an infrared image received at the reflector from the eye box toward the image display, wherein the reflector includes:
a visible reflective layer that reflects the visible image;
an intermediate layer adjacent to the visible reflective layer and operational to block the visible image and transmit the infrared image; and
an infrared reflective layer adjacent to the intermediate layer, on an opposite side of the intermediate layer as the visible reflective layer, and operational to reflect the infrared image.

13. The method according to claim 12, wherein the infrared reflective layer is tilted relative to the visible reflective layer to direct the infrared image received from the eye box toward the periphery of the image display.

14. The method according to claim 13, wherein a thickness of the intermediate layer varies from one side of the reflector to an opposite side to establish the tilt of the infrared reflective layer relative to the visible reflective layer.

15. The method according to claim 12, further comprising:
detecting the infrared image reflected by the reflector with an infrared camera.

16. The method according to claim 15, further comprising:
reflecting the infrared image toward the infrared camera with a mirror disposed on the periphery of the image display.

17. The method according to claim 15, further comprising:
transmitting the visible image from the active area of the image display through an infrared mirror to the visible reflective layer; and
reflecting the infrared image from the infrared reflective layer off the infrared mirror to the infrared camera.

18. The method according to claim 15, further comprising:
directing the infrared image toward the infrared camera with a nonplanar shape of the infrared reflective layer.

19. The method according to claim 12, further comprising:
supporting mechanically the infrared reflective layer with a substrate.

20. A vehicle comprising:
a heads-up display operational to project an visible image into an eye box, wherein the heads-up display includes:
an image display that has an active area and a periphery around the active area, wherein the image display is operational to project a visible image from the active area; and
a reflector optically aligned with the image display, wherein:
the reflector is oriented to reflect the visible image received from the image display toward the eye box, and reflect an infrared image received from the eye box toward the image display, wherein the eye box is a three-dimensional region in which a user of the heads-up display sees the visible image; and
the reflector includes:
a visible reflective layer that reflects the visible image;
an intermediate layer adjacent to the visible reflective layer and operational to block the visible image and transmit the infrared image; and
an infrared reflective layer adjacent to the intermediate layer, on an opposite side of the intermediate layer as the visible reflective layer, and operational to reflect the infrared image.
